(19) United States
(12) Patent Application Publication
(10) Pub. No.: US 2009/0327020 A1
(43) Pub. Date: Dec. 31, 2009

(54) Intelligent task Deactivation In Project Scheduling Application

(75) Inventors: Peter de Vries, Seattle, WA (US); Alice Pritikin Steinglass, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/163,311

(22) Filed: Jun. 27, 2008

(51) Int. Cl. G06F 19/00

(52) U.S. Cl. 705/9

(57) ABSTRACT

A project management application is provided in which an active or not active task state for each task may be displayed in a user interface. The active or not active task state would indicate whether the task is inactive or active. If the state of a task is active, the project management application may treat the active task as a normal task in the project plan. If the state of a task is inactive, the project management application may treat the inactive task as having no effect and may ignore the inactive task for scheduling purposes in the project plan. The project management application may maintain and display information of the inactive tasks in the project plan. The project management application may display the inactive tasks in a different style from the active tasks in the user interface.

### BACKGROUND

Project managers often use electronic scheduling tools and/or applications, such as electronic project management applications, to plan and run their projects. Project plans are made up of tasks and resources which are assigned to work on the tasks. Electronic project management applications help the project manager determine the relationships between tasks, track costs, and make assignments of resources to the tasks in order to optimize one or more aspects of the project. As the project progresses, some tasks may need to be removed so that time or budgetary requirements are met. However, when a task or set of tasks are removed from a project plan, they are removed completely and without any audit trail. Project managers would like to know and keep track of information of a task that is removed from a project during the project's execution. The project manager must refer to old saved copies of the project file to see what was removed. There is no easy or deterministic way to gain access to this information. In addition, the project manager may also want to make a conditional scheduling to evaluate different scheduling options while maintaining the costs, constraints, dependencies and resource schedule information of a project in one plan.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments of the present invention solve the above and other problems by providing for scheduling tasks via a project management application. According to one embodiment, a project management application is provided in which an “active or not active” (hereafter, active or not active) task state for each task is displayed in a user interface. The active or not active task state indicates whether the task is inactive or active. If the state of a task is active, the project management application treats the active task as a normal task in the project plan. If the state of a task is inactive, the project management application treats the inactive task as having no effect and may ignore the inactive task for scheduling purposes in the project plan. However, the project management application may maintain and display information of the inactive tasks in the project plan.

The project management application may deactivate an active task so that the task becomes inactive. The project management application may reactivate a previously deactivated task and restore the project plan to its previous state. The project management application may display the inactive tasks in a different style from the active tasks in the user interface.

According to one embodiment, the project management application allows a user to perform conditional scheduling by allowing choices of different scheduling options while maintaining the options information of the project in one plan. The user may enter multiple sets of tasks as optional tasks while keeping only one of the multiple sets of tasks to be activated and the rest of the multiple sets of tasks to be deactivated. The user may evaluate the potential alternatives by deactivating the current optional task and activating a different optional task.

These and other features and advantages, which characterize the present invention, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a simplified block diagram of an example computing operating environment in which embodiments of the present invention may be practiced.

FIG. 2 is a simplified block diagram illustrating the project management application of FIG. 1.

FIGS. 3A and 3B are simplified illustrations of a Gantt chart view of a project management application including a table view and a bar view for scheduling a given project where the project management application provides an active or not active task property which defines a task state to be active or inactive.

FIGS. 4A and 4B illustrate the Gantt chart view including the table view and the bar view when a task and its subtasks of the given project illustrated in FIGS. 3A and 3B are deleted.

FIGS. 5A and 5B illustrate the Gantt chart view including the table view and the bar view when a task and its subtasks of the given project illustrated in FIGS. 3A and 3B are deactivated.

FIGS. 6A and 6B illustrate another Gantt chart view of a project management application including a table view and a bar view for conditional scheduling when a first optional task of a given project is activated and a second optional task is deactivated.

FIGS. 7A and 7B illustrate the Gantt chart view including the table view and the bar view for conditional scheduling when the first optional task of a given project of FIGS. 6A and 6B is deactivated and the second optional task is activated.

### DETAILED DESCRIPTION

As briefly described above, embodiments of the present invention are directed to scheduling tasks via a project management application. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

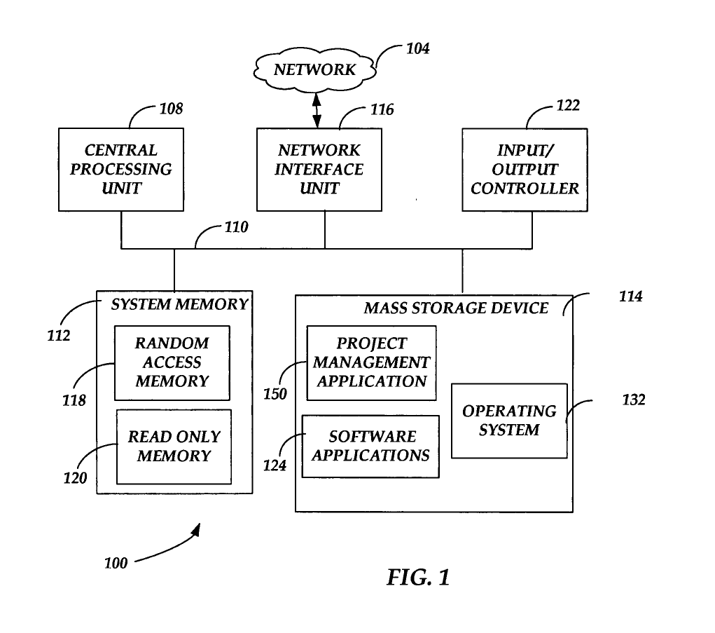

Referring now to the drawings, in which like numerals refer to like elements through the several figures, aspects of the present invention and an exemplary computing operating environment will be described. FIG. 1 and the following discussion are intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices. In addition, the invention may be practiced in an Internet web-based environment where components of the invention, including rich client user interface components, described and illustrated herein, may be hosted in a website remote from users of the components of any given embodiment of the invention.

Referring now to FIG. 1, an illustrative operating environment for embodiments of the invention will be described. As shown in FIG. 1, computer 100 comprises a general purpose desktop, laptop, handheld, mobile or other type of computer (computing device) capable of executing one or more application programs. The computer 100 includes at least one central processing unit 108 (“CPU”), a system memory 112, including a random access memory 118 (“RAM”) and a read-only memory (“ROM”) 120, and a system bus 110 that couples the memory to the CPU 108. A basic input/output system containing the basic routines that help to transfer information between elements within the computer, such as during startup, is stored in the ROM 120. The computer 102 further includes a mass storage device 114 for storing an operating system 132, application programs, and other program modules.

The mass storage device 114 is connected to the CPU 108 through a mass storage controller (not shown) connected to the bus 110. The mass storage device 114 and its associated computer-readable media provide non-volatile storage for the computer 100. Although the description of computer-readable media contained herein refers to a mass storage device, such as a hard disk or CD-ROM drive, it should be appreciated by those skilled in the art that computer-readable media can be any available media that can be accessed or utilized by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments of the invention, the computer 100 may operate in a networked environment using logical connections to remote computers through a network 104, such as a local network, the Internet, etc. for example. The computer 100 may connect to the network 104 through a network interface unit 116 connected to the bus 110. It should be appreciated that the network interface unit 116 may also be utilized to connect to other types of networks and remote computing systems. The computer 100 may also include an input/output controller 122 for receiving and processing input from a number of other devices, including a keyboard, mouse, etc. (not shown). Similarly, an input/output controller 122 may provide output to a display screen, a printer, or other type of output device.

As mentioned briefly above, a number of program modules and data files may be stored in the mass storage device 114 and RAM 118 of the computer 100, including an operating system 132 suitable for controlling the operation of a networked personal computer, such as the WINDOWS® operating systems from Microsoft Corporation of Redmond, Wash. The mass storage device 114 and RAM 118 may also store one or more program modules. In particular, the mass storage device 114 and the RAM 118 may store application programs, such as a software application 124, for example, a word processing application, a spreadsheet application, a slide presentation application, a database application, etc.

The mass storage device 114 and the RAM 118 may also store a project management application 150. According to embodiments of the present invention, an example of a suitable project management application 150 is MICROSOFT OFFICE PROJECT manufactured by Microsoft Corporation of Redmond, Wash.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

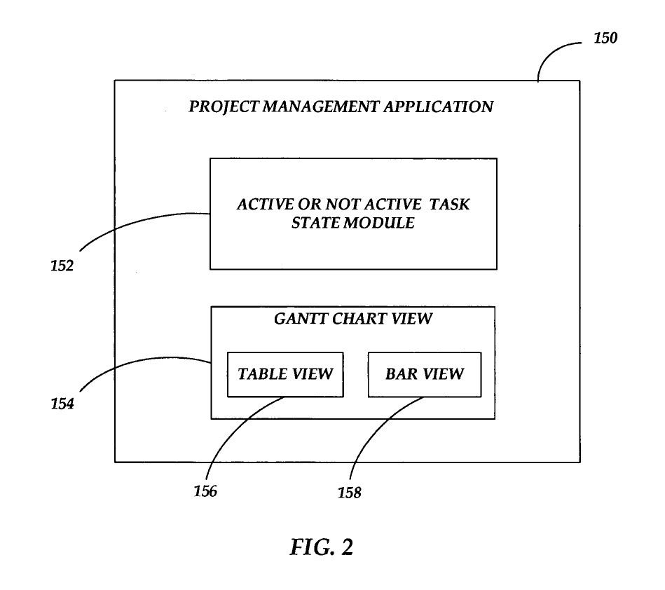

FIG. 2 is a simplified block diagram illustrating the project management application 150 of FIG. 1. As discussed above, an example of a suitable project management application 150 is MICROSOFT OFFICE PROJECT manufactured by Microsoft Corporation of Redmond, Wash. The project management application 150 may include a Gantt chart view 154 and an active or not active task state module 152. The Gantt chart view 154 may be configured to be a graphical view that contains a table view 156 where the project managers create a project plan and a bar view 158 where information from the table view 156 is graphically presented. The table view 156 is typically on the left side of the Gantt chart view 154. The bar view 158 is typically on the right side of the Gantt chart view 154. The Gantt chart view 154 may be configured to illustrate start and finish dates of beginning and ending tasks and a summary of tasks occurring between the beginning and ending tasks for a given project. The Gantt chart view 154 may show the workflow of a project based on tasks required for the project, including constraints and dependencies for tasks in relation to other tasks of a given project.

According to an embodiment, the active or not active task state module 152 is configured to create and support a task property, “active or not active”. The active or not active property is a property that defines a state of a task. The state of a task may be active or inactive. According to one embodiment, the active or not active task property may be a Boolean which may have “yes” for “inactive” and “no” for “active.” The active or not active task property is configured to change between “active” and “inactive” by a menu option, toolbar button, or any other suitable way, as should be appreciated by those skilled in the art.

A project manager or user (the terms “project manager” and “user” may alternatively be used in the discussion herein) may deactivate a task. When a task is deactivated, it becomes inactive. The deactivated task does not disappear from view totally. The inactive state may be indicated in a user interface (e.g., the Gantt chart view 154) of the project management application 150 by coloring the task and its attributes a light grey as opposed to black or dark blue as tasks are traditionally rendered. As should be appreciated by those skilled in the art, many other suitable embodiments may be configured to indicate a state of an inactive task in a user interface or like.

According to an embodiment, an inactive task no longer affects the project plan. Costs and scheduling constraints associated with the inactive task are ignored by the project management application's scheduling engine. In some ways, the project management application 150 behaves as if the inactive task were in fact deleted. However, the benefit of this active or not active task state property is that inactive tasks are not deleted. The inactive tasks remain stored in memory and in the project plan file, along with all of their costs, constraints, dependencies and resource schedules information. Thus, this information is still accessible to the project manager after the task has been deactivated. Additionally, the project management application 150 supports “reactivating” tasks, which allows the inactive task to be returned to active or normal status. Since all previously entered information in regards to the tasks is maintained, the project plan can be completely restored to the state it was in before the tasks were deactivated. Typically, deactivating a task may be done any time the project manager wants to experiment with removing, re-scoping or otherwise altering certain aspects of his/her project, without permanently committing to the removal of the potentially valuable task information. In addition, a project manager may add a buffering task in the project plan. By deactivating and reactivating the buffering task in the project plan, the project manager then may easily see what the scheduling, resources, costs and other information of the project will be with or without the buffering task.

According to one embodiment, subtasks of a larger abstract task may be grouped together under a parent, or “summary” task. A summary task summarizes (totals) the work of the child tasks underneath it. A summary task may have another summary task as one of its children. In this way, tasks groups can be nested to many levels of indent. According to one embodiment, if a summary task is deactivated, all of its child tasks may be automatically deactivated. Similarly, if an inactive summary task is made active, then all of its child tasks will be made active. If an inactive child task is activated, its summary task may be activated as well. However, in that case other children of the summary task may not be necessary to be reactivated. As should be appreciated, many other suitable embodiments, mechanisms and algorithms may be configured to deactivate and activate summary tasks while deactivating and activating their child tasks.

According to another embodiment, inactive tasks are still “live” in the sense that various aspects about them such as their dependencies, constraints and resource schedules information may still be accessible and editable. Scheduling and internal consistency calculations may still be carried out on the inactive tasks which are adjacent. This accessibility and consistency feature of an inactive task allows the project manager to continue to work with the inactive tasks without affecting the rest of the current plan of record, perhaps as a prelude to activating the tasks at a future date. The project manager thus may intelligently interact with the inactive portions of the project.

The functionality of deactivating a task may seem similar to deleting a task, and then later using the “undo” feature of the project management application 150 to undo the delete. However, there are important differences between them. First, when a task is deleted, all the information in regards to the task is removed from the plan. Hence there is no way to see or measure the scheduling information of deleted work. Second, undo only works within a single session of the application. When the project management application 150 is exited, or the project plan file is saved and given to another project manager or user, the other user cannot undo at that point. According to an embodiment of the present invention, inactive tasks may be activated at any time, even between application sessions or between different users over a large period of time. Third, a user may only undo operations in an exact order they were carried out (e.g., “first in first out” order). However, according to one embodiment of the present invention, sets of inactive tasks may be activated in any order.

According to an embodiment, the project management application 150 is configured to support a project manager or user for performing conditional scheduling by making a choice in different options while maintaining information of the project in one plan. For example, a project manager may plan two or more equivalent series of tasks, which all reach a same goal (but perhaps with different resource allocations or task orders). All but one of the series may be deactivated at any given time. This allows the project manager to easily evaluate the potential alternatives over time, and switch to a different option by deactivating the current optional task and activating a different optional task.

According to one embodiment, the project management application 150 may be configured to include a filter (not shown) to filter out inactive and active tasks. For example, in the Gantt chart view 154, a project manager or user may choose filter only active tasks, filter only inactive tasks, or filter to see both inactive and active tasks.

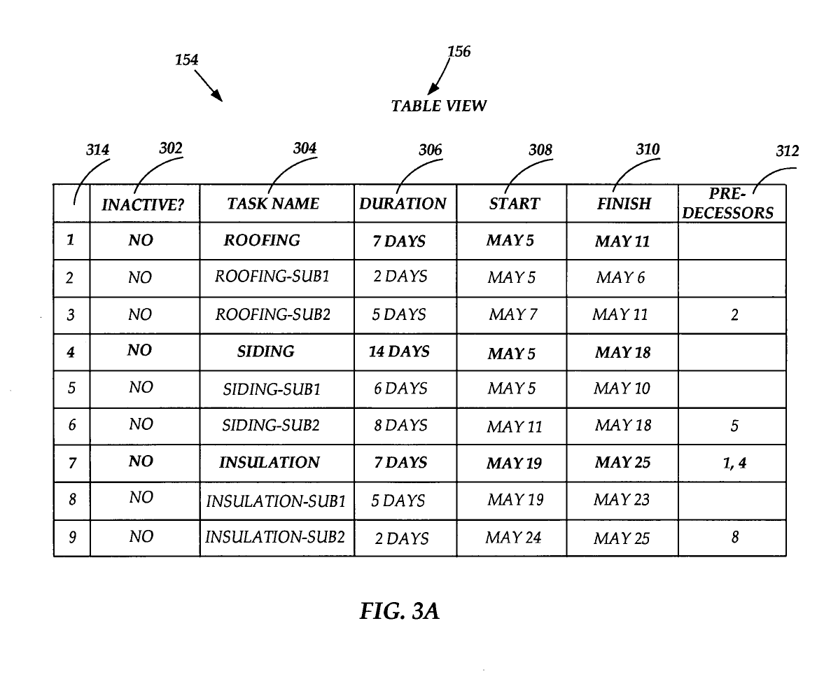

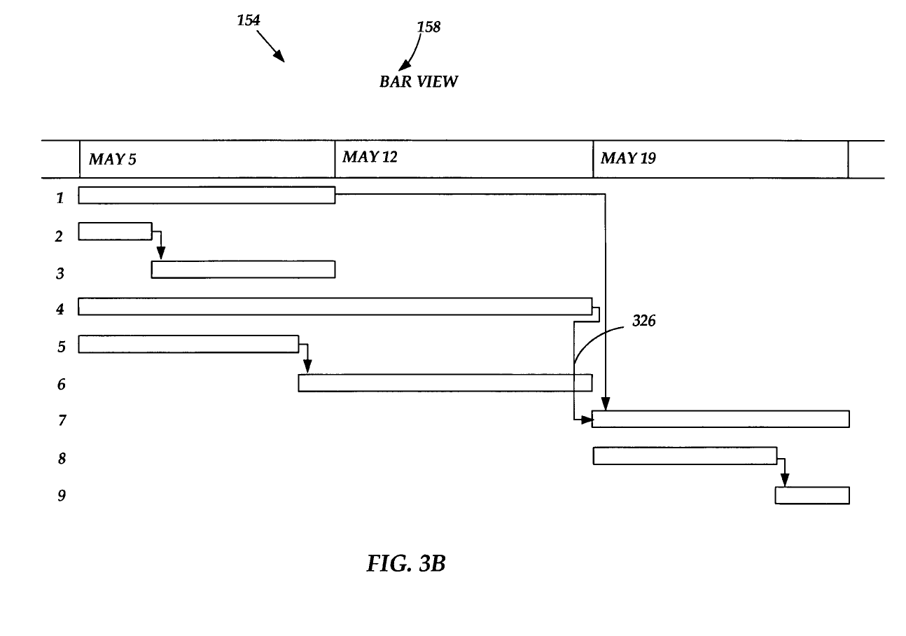

FIGS. 3A-7B are simplified illustrations of scheduling a project via a project management application 150 providing an active or not active task property which defines a task state to be active or inactive. For purposes of explanation of the present invention, example projects associated with building a house, including various tasks and sub-tasks associated with building a house will be described herein. As should be appreciated, description of the present invention in terms of a specific example project is for purposes of illustration only and is not limiting of the vast numbers of projects and associated tasks for which embodiments of the present invention may be utilized.

Referring to FIGS. 3A and 3B, a Gantt chart view (user interface) 154 including a table view 156 and a bar view 158 is illustrated for scheduling an example project in the project management application 150. The table view 156 is illustrated in FIG. 3A. The bar view 158 is illustrated in FIG. 3B. The bar view 158 may correspond to the table view 156 and may graphically present information from the table view 156.

Referring to FIG. 3A, the table view 156, which may be a portion of the Gantt chart view 154 and may typically be on the left side of the view, may include an “active or not active” column 302, a “task name” column 304, a “duration” column 306, a “start” column 308, a “finish” column 310 and a “predecessors” column 312. Tasks may be displayed one per row in the table view 156. Each row may have a row number 314 corresponding to each task. Properties of the task such as active or not active, task name, duration, start, finish and predecessors are in column headers. The actual value for each task appears in the corresponding cell. As should be appreciated, the information illustrated in the table view 156 is for purposes of example only and is not limiting of the vast numbers of different tasks and task properties that may be utilized in the table view 156 and the bar view 158, as described below.

The task name, duration, start, and finish columns 304, 306, 308, 310 display a task name, duration, start date, and finish date of each task respectively. For example, the task in row 1 is “roofing”. The roofing task has duration of seven (7) days for completing this task. Its start and finish dates are scheduled to be May 5 and May 11 respectively.

The predecessors column 312 displays a predecessor (if any) for each task. A task may start only after its predecessor is finished. For example, the task “insulation” (row 7) has the tasks “roofing” (row 1) and “siding” (row 4) as predecessors. The insulation task may start only after both the roofing and siding tasks are finished.

Additionally, as discussed above, subtasks of a larger abstract task may be grouped together under a parent, or “summary” task. A summary task summarizes (totals) the work of the child tasks underneath it. A summary task may have another summary task as one of its children. In this way, tasks groups can be nested, potentially to many levels of indent. In the example illustrated in FIG. 3A, the tasks “roofing”, “siding” and “insulation” are noted as summary tasks. They have tasks “roofing-sub1” and “roofing-sub2”, tasks “siding-sub1” and “siding-sub2”, and tasks “insulation-sub1” and “insulation-sub2” as their child tasks respectively. According to one embodiment, summary tasks may be noted by bold type in a table view 156, and a different bar style (not shown) from child tasks in a bar view 158.

The active or not active column 302 displays the actual value of the active or not active property of each task. As illustrated in the example project of FIG. 3A, each task currently has a “no” value under the active or not active column 302. According to an embodiment, the “no” value indicates that the task is currently not inactive. In other words, the task is actually active.

In the example project, the roofing task is scheduled to start on May 5 and runs for seven (7) days. The siding task is scheduled to start also on May 5 and runs for 14 days. The insulation task has the roofing and siding tasks as predecessors. Since the insulation task depends on both the roofing and siding tasks, the insulation task may start only after both the roofing task and the siding task are finished. The earliest date for the insulation task to start is scheduled on May 19.

Referring to FIG. 3B, the bar view 158, which may be another portion of the Gantt chart view 154 and may typically be on the right side of the view, is associated with the table view 156 of FIG. 3A and graphically presents information from the table view 156. Each task illustrated in FIG. 3A may be corresponding to a bar illustrated in FIG. 3B as noted with the row numbers 1-9 respectively. Each bar may graphically present duration, start date and finish date of a corresponding task. For example, the siding task is graphically illustrated being scheduled to start on May 5 and scheduled to finish on May 11. The bar view 158 may also graphically present a precedence relationship between tasks. A line with an arrow from a first task to a second task indicates that the first task must finish before the second task may start. For example, in the bar view 158, the line with an arrow 326 indicates the siding task (row 4) must finish before the insulation task (row 7) may start. As should be appreciated, the timing dependence illustrated here is not limiting other dependencies, constraints and resource schedules which may be utilized in the bar view 158 and the table view 156 of the Gantt chart view 154 of the project management application 150.

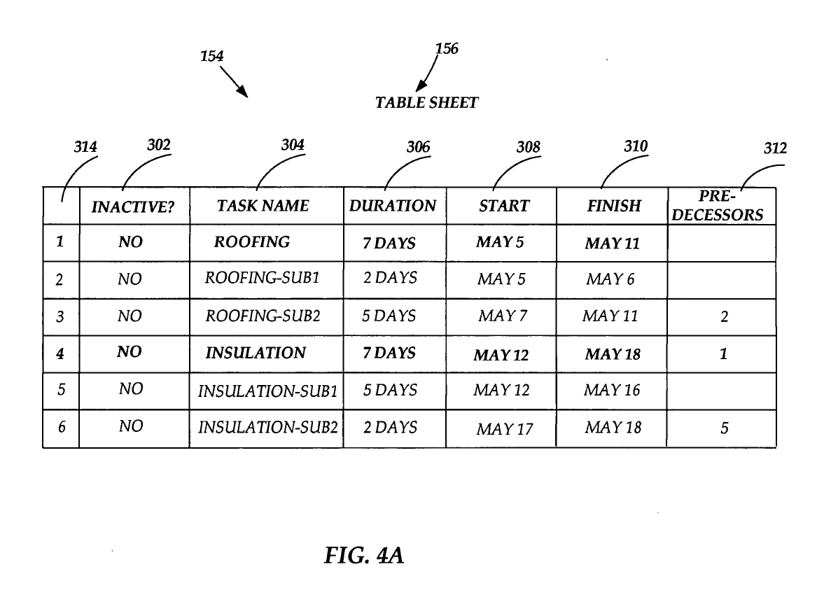

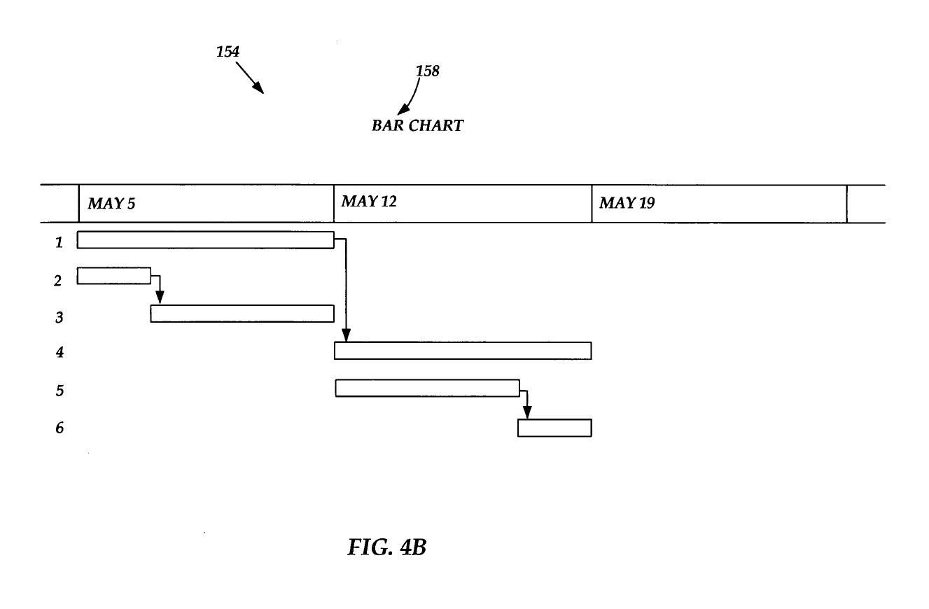

FIGS. 4A and 4B illustrate the Gantt chart view 154 with the table view 156 and the bar view 158 when the task “siding” and its subtasks of the example project illustrated in FIGS. 3A and 3B are completely deleted. As shown in FIGS. 4A and 4B, there is no evidence the siding task and its subtasks even existed. All the information in regards to the siding task and its subtasks is removed from the plan. Hence there may be no way for a user to see or measure the information and amount of deleted work from the views. Since the task “insulation” now has only the task “roofing” as a predecessor, it can start earlier (May 12 in this case). Previously it was scheduled to start on May 19 because the siding task did not complete until that point.

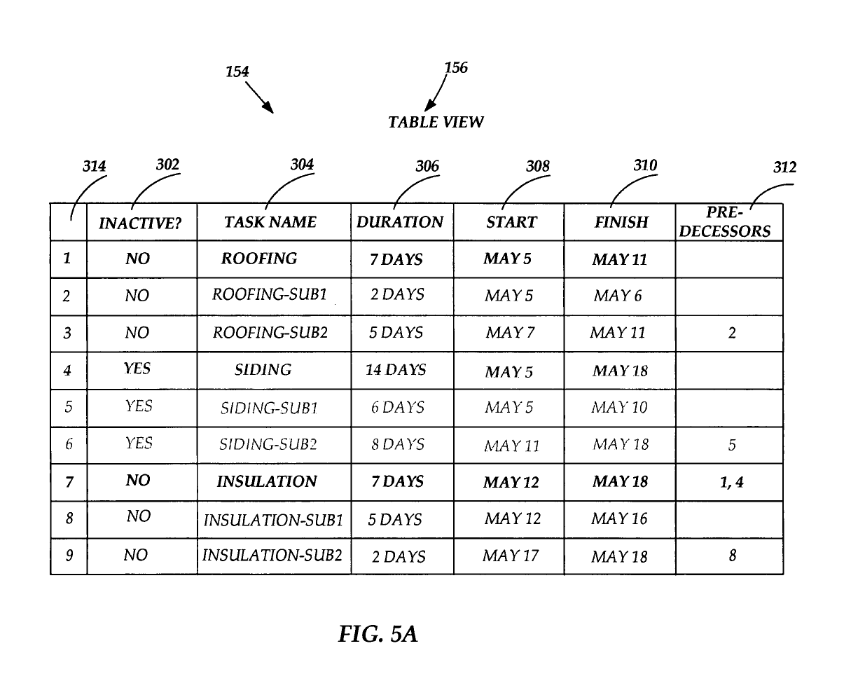

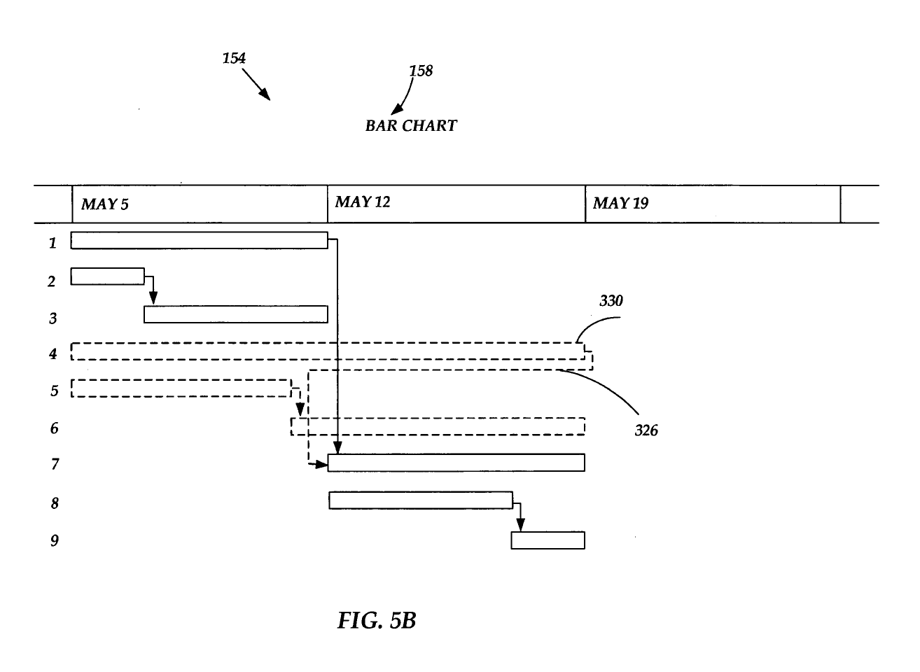

FIGS. 5A and 5B illustrate the Gantt chart view 154 with the table view 156 and the bar view 158 when the task “siding” of the example project illustrated in FIGS. 3A and 3B is deactivated. The siding task is deactivated and is now inactive. According to one embodiment, since the siding task is a summary task, its child tasks “siding-sub1” and “siding-sub2” may also be deactivated and would be inactive accordingly when deactivating the siding task. According to an embodiment, inactive tasks are shown by a “yes” in the inactive field and by coloring the inactive tasks and their attributes a light grey as opposed to black or dark blue as the active tasks are rendered. For purpose of illustration, the greyed out look to the bars and relationships of the present example in FIG. 5B is illustrated with dash-lines 330. As should be appreciated, the greyed out look illustrated here is not limiting other embodiments to indicate the inactive state of tasks.

The insulation task is now scheduled like it has only the roofing task as a predecessor, so it may start on May 12. The predecessor relationship to the siding task, which would have pushed the start date of the insulation task out to May 19, while still maintained in the plan (and visualized), is ignored for scheduling purposes. Still, precedence relationships and scheduling may be maintained within the set of inactive tasks. For example, the child task “siding-sub1” is still scheduled to start on May 5 as it would have had it not been inactive. Another child task “siding-sub2” is still affected by its predecessor task “siding-sub1”, and does not start until the siding-sub1 task finishes. The siding task may easily be reactivated by changing the active or not active property value of the siding task from “yes” to “no” and the situation would return to FIGS. 3A and 3B, as if nothing had happened. In other words, once the siding task is reactivated and becomes active again, the project plan illustrated in FIGS. 5A and 5B may be restored to its previous state as illustrated in FIGS. 3A and 3B.

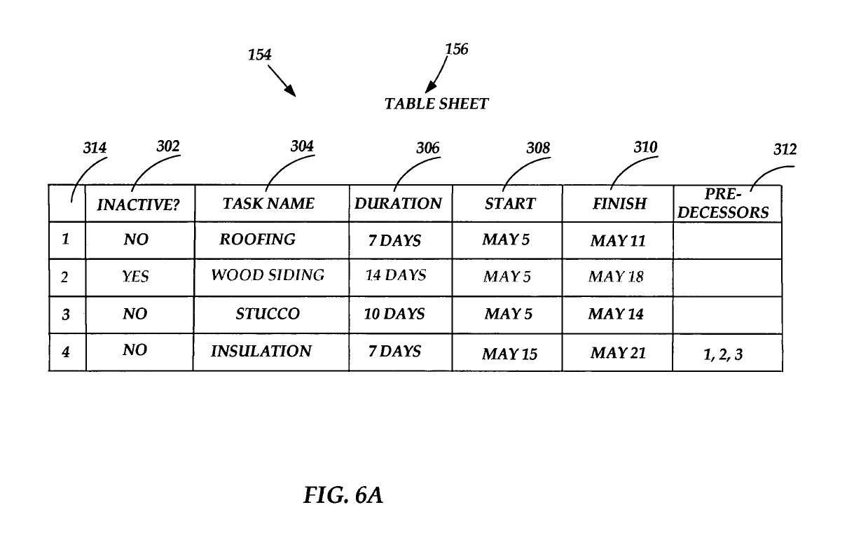

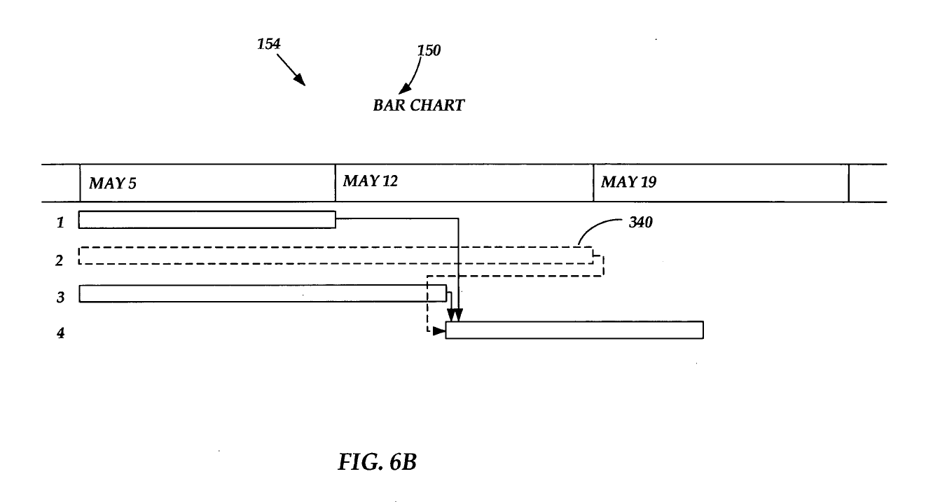

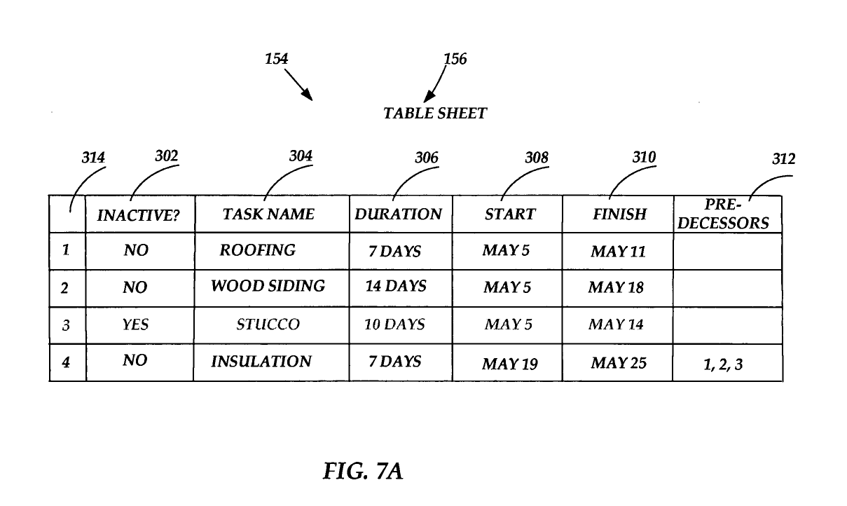

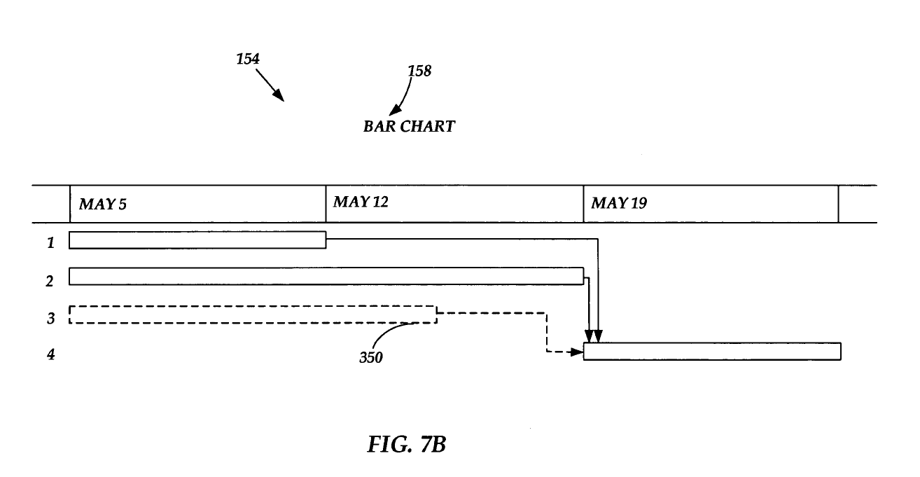

FIGS. 6A-7B are simplified illustrations of conditional scheduling via the project management application 150. The project management application 150 allows a project manager to generate conditional scheduling. The project manager is allowed to model conditions in his or her project plan and easily make a choice in different options while maintaining the scheduling, resources, costs and other information of the project in one plan. For example, a project manager may plan two or more equivalent series of tasks, which all may reach a same goal (but perhaps with different resource allocations or task orders). All but one of the series would be deactivated at any given time. When an optional task is selected, the relative scheduling and resources and costs may also be changed accordingly so that the project manager may easily evaluate the potential alternatives over time and switch to a different option by deactivating the current optional task and activating a different optional task.

In the example housing project illustrated in FIGS. 6A-7B, the project manager may have an option to choose between tasks “wood siding” and “stucco” which have been input in the project plan. The project manager may choose the stucco option by deactivating the wood siding option and activating the stucco option. The project manager then may see what the scheduling, resources, costs and other information of the project will be with the stucco option. As illustrated in FIGS. 6A-6B, the wood siding task is deactivated and becomes inactive. The stucco task is still active. The wood siding task is shown by a “yes” in the inactive field and by coloring the inactive task and its attributes a light grey as opposed to black or dark blue as the active tasks may be rendered. For purpose of illustration, the greyed out look to the bars and relationships of the wood siding task in FIG. 6B is illustrated with dash-lines 340. As should be appreciated, the greyed out look illustrated here is not limiting any other embodiments which may indicate the inactive state of tasks.

The task “insulation” may now be scheduled like it does not have the task “wood siding” as a predecessor. The insulation task may start on May 15 as the insulation task has the stucco task as a predecessor which will be finished on May 14.

The project manager may try it the other way. Namely, the project manager may deactivate the stucco task and activate the wood siding task to choose the wood siding option. As illustrated in FIGS. 7A and 7B, the stucco task is deactivated and becomes inactive. The wood siding task is reactivated and becomes active. The stucco task is shown by a “yes” in the inactive field and by coloring the inactive task and its attributes a light grey as opposed to black or dark blue as the active tasks may be rendered. For purpose of illustration, the greyed out look to the bars and relationships of the stucco task in FIG. 7B is illustrated with dash-lines 350. As should be appreciated, the greyed out look illustrated here is not limiting any other embodiments which may indicate the inactive state of tasks.

The insulation task is now scheduled like it does not have the stucco task as a predecessor. The start date of the insulation task is pushed out for four (4) days and the insulation task is scheduled to start on May 19 because the wood siding task, which is the predecessor of the insulation task and is scheduled to finish on May 18, is now active.

As illustrated above, the project manager may easily evaluate the potential alternatives (i.e., the “stucco” and “wood siding” options in the example illustrated in FIGS. 6A-7B) over time, and switch to a different option by deactivating the current optional task and activating a different optional task.

It should be appreciated that various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various embodiments, those of ordinary skill in the art will understand that many modifications may be made thereto within the scope of the claims that follow. Accordingly, it is not intended that the scope of the invention in any way be limited by the above description, but instead be determined entirely by reference to the claims that follow.

We claim:

1. A method of displaying tasks of a work project for a user to schedule a project plan in a project management application, comprising:
providing a user interface to display the project plan;
providing each task a state indicating whether the task is inactive or active;
if the state of a task is active, treating the task as a normal task in the project plan;
if the state of a task is inactive, treating the task as having no effect in the project plan and ignoring the task for scheduling purposes;
maintaining information of the inactive tasks in the project plan; and
displaying both inactive and active tasks in the user interface.

2. The method of claim 1, further comprising deactivating an active task to become inactive and maintaining information of the deactivated task in the project plan.

3. The method of claim 2, further comprising reactivating the previously deactivated task wherein reactivating the previously deactivated task restores the project plan to its previous state.

4. The method of claim 1, wherein displaying both inactive and active tasks in the user interface comprises displaying the inactive tasks in a different style from the active tasks.

5. The method of claim 4, wherein the inactive tasks are indicated in the user interface by coloring the inactive tasks and their attributes a light grey as opposed to black or dark blue as the active tasks are rendered.

6. The method of claim 1, wherein providing the user interface comprises providing a menu option to deactivate and activate a task.

7. The method of claim 1, wherein maintaining information of the inactive tasks includes maintaining constrains, dependencies and resource schedules information of the inactive tasks wherein the maintained information enables the user to do reporting and analysis of the inactive tasks over time.

8. The method of claim 1, further comprising:
wherein multiple sets of tasks are entered as optional tasks;
wherein only one of the multiple sets of tasks is activated and the rest of the multiple sets of tasks are deactivated;
allowing the user to perform conditional scheduling by making a choice in different options while maintaining the options information of the project in one plan; and
allowing the user to evaluate the potential alternatives by deactivating the current optional task and activating a different optional task.

9. The method of claim 1, wherein the information of the inactive tasks is accessible and editable and the inactive tasks are scheduled in the inactive task portions so that the user may intelligently interact with the inactive task portions without affecting the rest of the current project plan.

10. The method of claim 1, further comprising:
providing a filter to filter the inactive and active tasks; and
displaying the filtered tasks in the user interface.

11. A computer-readable storage medium containing computer executable instructions which when executed by a computer perform a method of displaying tasks of a work project, comprising:
providing a user interface to display the project plan;
providing each task a state indicating whether the task is inactive or active;
if the state of a task is active, treating the task as a normal task in the project plan;
if the state of a task is inactive, treating the task as having no effect in the project plan and ignoring the task for scheduling purposes;
deactivating an active task to become inactive;
reactivating a previously deactivated task wherein reactivating the previously deactivated task restores the project plan to its previous state;
maintaining information of the inactive tasks in the project plan; and
displaying the inactive tasks in a different style from the active tasks in the user interface.

12. The computer-readable storage medium of claim 11, wherein the actions of deactivating the active task and reactivating the previously deactivated task are taken in a same application session, between application sessions or between different users over a period of time.

13. The computer-readable storage medium of claim 11, wherein the inactive tasks are indicated in the user interface by coloring the inactive tasks and their attributes a light grey as opposed to black or dark blue as the active tasks are rendered.

14. The computer-readable storage medium of claim 11, wherein providing the user interface comprises providing a toolbar button to deactivate and activate a task.

15. The computer-readable storage medium of claim 11, wherein maintaining information of the inactive tasks includes maintaining constrains, dependencies and resource schedules information of the inactive tasks.

16. The computer-readable storage medium of claim 11, further comprising:
wherein multiple sets of tasks are entered as optional tasks;
wherein only one of the multiple sets of tasks is activated and the rest of the multiple sets of tasks are deactivated;
allowing the user to perform conditional scheduling by making a choice in different options while maintaining the options information of the project in one plan; and
allowing the user to evaluate the potential alternatives by deactivating the current optional task and activating a different optional task.

17. A project management system for scheduling tasks of a work project, comprising:
an active or not active task state module programmed to provide each task a state indicating whether the task is inactive or active, an active task being treated as a normal task in a project plan, an inactive task being treated as having no effect in the project plan and being ignored for scheduling purposes; and
a user interface programmed to:
deactivate an active task to become inactive,
reactivate a previously deactivated task,
restore a project plan to its previous state after reactivating the previously deactivated task,
maintain information of the inactive tasks in the project plan, and
display the inactive tasks in a different style from the active tasks in the user interface.

18. The project management system of claim 17, further comprising a filter programmed to filter the inactive and active tasks and display the filtered tasks in the user interface.

19. The project management system of claim 17, wherein the information of the inactive tasks is accessible and editable and the inactive tasks are scheduled in the inactive task portions so that the user may intelligently interact with the inactive task portions without affecting the rest of the current project plan.

20. The project management system of claim 17, wherein the information of the inactive tasks includes constrains, dependencies and resource schedules information of the inactive tasks wherein the maintained information enables a user to do reporting and analysis of the inactive tasks over time.
